(19) United States
(12) Patent Application Publication
(10) Pub. No.: US 2013/0132117 A1
(43) Pub. Date: May 23, 2013

(54) GRAPHICAL TOOL FOR MANAGING A LONGITUDINAL PATIENT EPISODE

(71) Applicant: The Cleveland Clinic Foundation, Cleveland, OH (US)

(72) Inventors: Wael K. Barsoum, Bay Village, OH (US); William H. Morris, Shaker Heights, OH (US); Douglas R. R. Johnston, Shaker Heights, OH (US); Michael W. Kattan, Cleveland, OH (US)

(73) Assignee: THE CLEVELAND CLINIC FOUNDATION, Cleveland, OH (US)

(21) Appl. No.: 13/679,414

(22) Filed: Nov. 16, 2012

Related U.S. Application Data
(60) Provisional application No. 61/560,985, filed on Nov. 17, 2011.

(51) Int. Cl. G06Q 50/24

(52) U.S. Cl. CPC G06Q 50/24
USPC 705/3

(57) ABSTRACT

Systems and methods are disclosed for graphical-based management and documentation of longitudinal care episodes. As one example, a system to manage a longitudinal care episode for a patient can include a patient data aggregator, executable by a processor, to provide context data for the patient, at least a portion of the context data including patient data associated with multiple phases of the longitudinal care episode. A tool manager can translate user interactions with an associated graphical user interface (GUI) into corresponding discrete concepts. The corresponding discrete concepts can be stored in memory as part of longitudinal episode data for the patient, the longitudinal episode data being generated based on the context data and in response to user interactions with the GUI to facilitate documentation and management of the longitudinal care episode.

### CROSS-REFERENCE TO RELATED APPLICATION

This application claims the benefit to U.S. Provisional Patent Application No. 61/560,985, filed Nov. 17, 2011, and entitled GRAPHICAL TOOL FOR MANAGING A LONGITUDINAL PATIENT EPISODE, the contents of which is incorporated herein by reference in its entirety.

### TECHNICAL FIELD

This disclosure relates to a graphical tool for managing a longitudinal patient episode.

### BRIEF DESCRIPTION OF THE DRAWINGS

FIG. 1 depicts an example of a graphical management tool that can be implemented.

FIG. 2 depicts an example of a system to facilitate documentation consistency for a longitudinal patient care episode.

FIG. 3 depicts an example of a prediction system that can be utilized in a longitudinal patient care episode.

FIGS. 4-20 demonstrate examples of a graphical user interface and workflow that can be utilized to implement a tool such as disclosed herein.

FIG. 21 depicts an example of a computing environment.

### SUMMARY

This disclosure relates to a graphical tool for managing a longitudinal patient episode.

As one example, a system to manage a longitudinal care episode for a patient can include a patient data aggregator, executable by a processor, to provide context data for the patient, at least a portion of the context data including patient data associated with multiple phases of the longitudinal care episode. A tool manager can translate user interactions with an associated graphical user interface (GUI) into corresponding discrete concepts. The corresponding discrete concepts can be stored in memory as part of longitudinal episode data for the patient, the longitudinal episode data being generated based on the context data and in response to user interactions with the GUI to facilitate documentation and management of the longitudinal care episode.

As another example, a non-transitory computer-readable medium can include instructions which, when executed by a processor, cause the processor to aggregate context data for a patient, at least a portion of the context data including patient data associated with a longitudinal care episode. The instructions can also cause the processor to provide a graphical user interface (GUI) responsive to user interactions. The instructions can also cause the processor to translate the user interactions with the GUI into corresponding discrete concepts. The instructions can also cause the processor to generate and store longitudinal episode data based on the context data and in response to the user interactions with the GUI and to store the corresponding discrete concepts in memory as part of the longitudinal episode data for the patient. In this way, documentation and management of multiple phases of the longitudinal care episode is facilitated.

### DETAILED DESCRIPTION

This disclosure relates systems and methods for graphical-based management and documentation of longitudinal patient care episodes. As used herein, a longitudinal care episode for a given patient can encompass one or more health conditions for the given patient. Additionally, a longitudinal care episode can include interactions with any number of one or more caregivers over an extended period of time that may involve patient consultation (e.g., planning, examination, or other assessments), interventions, testing, procedures (e.g., surgical or otherwise), post-procedure care as well as other health-related interactions. The systems and methods disclosed herein provide a context-driven graphical user interface (GUI) to further facilitate accurate and detailed documentation for each such aspect of longitudinal care. Because the documentation for each phase of a given longitudinal care episode is linked together, detailed information is readily available through the course of care without requiring complex queries or complicated user interactions.

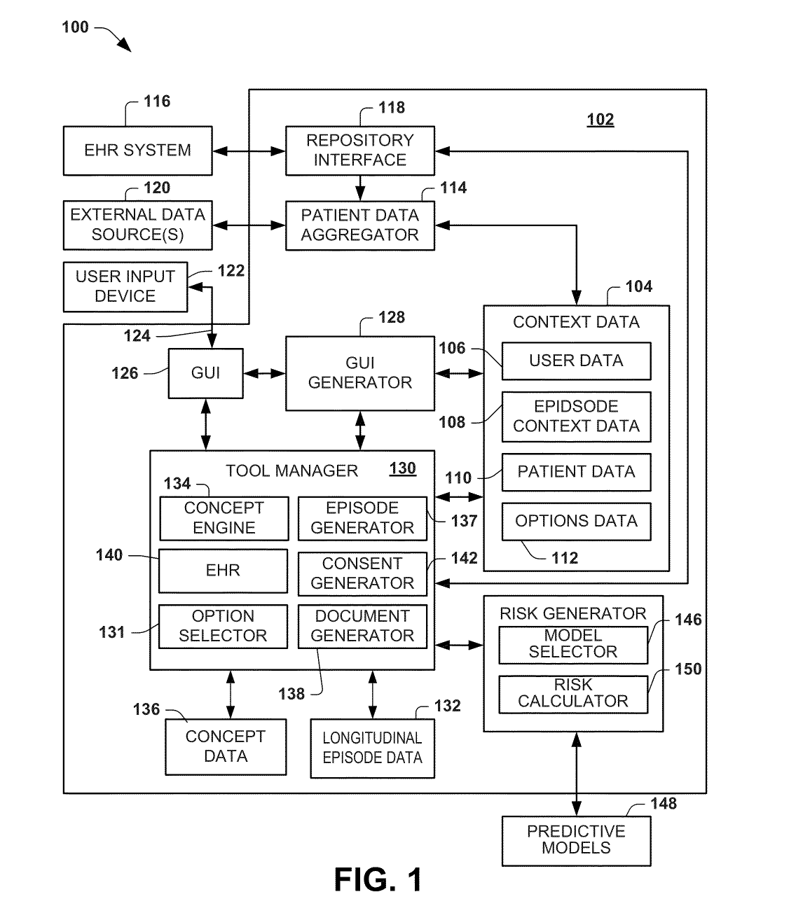

FIG. 1 demonstrates an example of a system 100 that includes a tool 102 to enable caregivers to effectively and efficiently manage and document care for a given patient longitudinally over a period of time. The tool 102 can include instructions and data that are stored in one or more non-transitory machine readable media (e.g., volatile or non-volatile memory). The instructions and data of the tool can be accessed by a processor and executed to perform functions and methods disclosed herein. Additionally, a machine (e.g., a special purpose computer) can be programmed to implement the functions and methods of the tool 102.

In the example of FIG. 1, the tool 102 employs context data 104 for a given patient. The context data 104 enables the tool to provide an adaptive, context-specific graphical user interface (GUI) 128 that selectively provides a pertinent set of GUI elements for interacting with the user. The context data 104 can include user data 106, episode context data 108, patient data 110 and options data 112.

As an example, the patient data 110 can include problem list data associated with the patient for the current encounter. The problem list data can be obtained from a patient's medical record (e.g., from the EHR repository), from the patient as well as from a care giver during a given episode. Problem list data for a given encounter can encompass all active problems associated with the patient for the given encounter. This may be contrasted to the patient's entire medical history from the EHR, which can include active problems (e.g., from the problem list) and other past problems, including deactivated problems, associated with the patient. For example, problem list data can include past and existing diagnosis, pathophysiological states, potentially significant abnormal physical signs and laboratory findings, disabilities, and unusual conditions. Other factors such as social problems, psychiatric problems, risk factors, allergies, reactions to drugs or foods, behavioral problems, or other health alerts pertaining to the active issues further may be included in the problem list data.

As a further example, the entries in the active problem list in the context data 104 can include and/or be linked or mapped to one or more proprietary or standardized code sets, such as International Classification of Diseases (ICD) codes (e.g., ICD-9 and/or ICD-10 codes), Systematized Nomenclature of Medicine (SNOMED) codes (e.g., SNOMED Clinical Terms (CT) codes), Current Procedural Terminology (CPT) codes, Healthcare Common Procedure Coding System (HCPCS) codes (e.g., HCPCS-level I and HCPCS-level II), Durable Medical Equipment (DME) codes, anatomic correlations and the like. These and other codes, which may vary depending on location or care giver affiliations, thus can be utilized to represent data elements in the active problem list for a given patient encounter. The codes can also specify scheduled procedures and medical services for the patient as well as specify medical services and procedures that have been performed for the patient for the given episode. The specificity and meaning afforded to such codes further can vary depending on the phase of the episode (e.g., pre-procedure, intra-procedure and post-procedure). Each of these codes can correspond to a data element in the patient data 110, for example, which can vary throughout the longitudinal care episode.

The context data 104 can be selectively aggregated from a plurality of disparate sources for a given longitudinal care episode. For example, the tool 102 can include a patient data aggregator 114 programmed to collect and combine patient data from one or more sources. The sources of patient data can include one or more electronic health record (EHR) systems 116. The patient data aggregator 114 can obtain data for a given patient from the EHR system 116 via an EHR interface 118 that is programmed (e.g., a set of application program interfaces) to acquire data from any number of one or more EHR systems 116. The tool 102 can be configured to operate with any type of EHR system.

As a further example, the patient data aggregator 114 can query the EHR system 116 via the interface 118 to retrieve pertinent data for a given patient. The query can vary depending on the context data 104. For example, the patient data aggregator 114 can acquire patient data and active problem list data based on user data 106, such that the information retrieved may have an increased relevance for a given user. For instance, a cardiothoracic surgeon who is planning a heart valve replacement may have need for a different result set than an orthopedic surgeon planning a hip replacement procedure. Alternatively, a generic set of detailed patient data can be retrieved regardless of the context data 104 and the GUI 126 can selectively present information and options to the user based on the context data (e.g., including the user data 106). In some examples, problem list data, such as may be coded according to a corresponding standard (e.g., ICD and/or SNOMED), can be obtained from the EHR system 116.

The patient data aggregator 114 can also obtain data for one or more other external sources 120. The other external sources 120 can include patient data from a referring physician, such as can be provided in a variety of forms and file formats. Other sources of external data can be thumb drives, email messages or other databases and repositories to which individuals may store relevant patient data, including forms and other information that may be entered into the system 100. The other sources 120 may also include other systems, such as scheduling systems, inventory and tracking systems, billing systems or the like. The patient data aggregator 114 thus can obtain the data from these sources 120 and combine it with patient data (e.g., active problem list data) acquired from the EHR system 116 to provide the corresponding patient data 110.

The tool 102 can also include one or more user input devices 122 with which one or more users can to interact with the tool 102. The user input device 122 can correspond to a work station, a personal computer, a hand held computing device (e.g., smart phone, tablet computer, PDA or the like). The user input device 122 can communicate with the tool 102 directly or via a network connection indicated schematically at 124. The user input device can include a display that can present the GUI 126 and receive user inputs that are provided to the tool corresponding to user interactions.

A GUI generator 128 can be programmed to generate the GUI 126 based on the context data 104. By way of example, the GUI generator 128 can construct the GUI 126 based on user data 106, episode context data 108, patient data 110 and the options data 112. The GUI generator 128 can employ a general graphical framework that remains consistent for a set of users, yet also adapts based on the episode context data 108, patient data 110 and options data 112. The user data 106 can characterize a user of the tool 102, such as including a user's role (e.g., a physician, nurse, nurse practitioner or other health care provider) and preferences within the system 100. The user data 106 or the episode context data 108 further can specify more detailed aspects about the user's role in a given phase of the longitudinal care episode. For example, the user data 106 can specify that the user is a cardiothoracic surgeon and the episode context data 108 can specify that the user intends to perform a particular type of procedure as well as the phase of the respective episode (e.g., pre-procedure phase initially). Thus, the GUI generator 128 can select information from the context data 104 to generate the GUI 126 with appropriate information and options. In another example, the user may also be a patient, such that the corresponding GUI 126 and information provided can be adjusted according to the intended recipient and user of the tool 102. Thus, the GUI generator 128 can implement context-based controls to construct the corresponding GUI based on specific details of the user's role and preferences as well as patient condition.

A tool manager 130 can be programmed to manage the context data 104. For example, the tool manager 130 can be programmed to provide the episode context data 108 as relevant subset of data depending based on the user's role in dealing with the respective patient, problems experienced by the patient (from the patient data 110). The tool manager 130 can selectively provide the options data 112 based on the episode context data 108 such that the GUI generator 128 can provide a set of relevant GUI elements in the GUI 126. For example, the tool manager can select which options and information and graphics are presented to the user as option GUI elements based upon the context data 104 and user's interaction therewith. The option GUI elements can vary depending upon, for example, whether the course of treatment is surgical or non-surgical or whether other interventions are to be implemented and based on the user's role as provided by the user data 106.

The tool manager 130 can also include an option selector 131 to select options for the options data 112. The options can include tools, procedures, medications that can be applied to or received from the patient. For example, the option selector 131 can select a subset of pertinent options based upon the user role and user preferences that can be stored as part of the user data 106 as well as based on the episode context data 108, which can define a state or condition for the GUI 126. As one example, a given surgeon may prefer to have certain types of implants available as options and the option selector can present GUI elements in the GUI 126 based on such preferences, which the user can manipulate via the GUI 126. The system 100 can learn user preferences over time as to present each user with relevant information and a look and feel depending on such user preferences.

The tool manager 130 can also provide and maintain longitudinal episode data 132, corresponding to discrete concepts, based on the context data 104, user data 106 and in response to the user interactions with the GUI 126. The tool manager 130 can include a concept engine 134 that is programmed to translate user interactions with the GUI 126 into corresponding discrete concepts. The resulting discrete concepts can be stored in memory as part of the longitudinal episode data 132. The discrete concepts can be linked together in an ordered construct to provide detailed information about the patient care episode. For example, the ordered construct can order the longitudinal data according to phase and subphase of the episode. Other temporal (discrete or continuous time intervals) and logical constructs can be utilized by the concept engine 134 to link the data into a suitable construct. The concept data 136 can further be programmatically associated with patient data (e.g., including data elements corresponding to codes, such as ICD and/or CPT codes) 110 as well as other parts of the context data 104 for each phase of the episode. The specificity of the discrete concepts can vary depending on the phase of the longitudinal care episode as well as available context data for generating the longitudinal episode data 132.

As a further example, the concept engine 134 can be programmed to provide the discrete concepts based on concept data 136 stored in memory or to construct the concepts in response to user interactions with the GUI 126. As one example, the concept engine 134 can construct a query to search the concept data 136 for a corresponding discrete concept in response to a user interaction via the GUI 126, which query can be constructed based on the user input (e.g., where the interaction occurred and the type of interaction on the GUI), the episode context data 108 (e.g., representing the procedural context for the given GUI) and the user data 106. In some examples, the concept engine 134 can be implemented as including or accessing an expert system or other artificial intelligence programmed (e.g., with an inference engine) to construct the discrete concepts (from a knowledge base—corresponding to the concept data 136) in response to a user interaction with the GUI 126. The discrete concepts that the concept engine 134 generates to provide the longitudinal data 136 may also be determined based on other context data 104 for the given patient, including an active problem list for the patient obtained from the EHR system 116.

As one example, the GUI 126 can include an interactive graphical representation of patient anatomy and a user interaction (e.g., drawing a line at a particular anatomic location) can correspond to the concept of making an incision at such location. As another example, a user can drag an implant GUI element (selected by the GUI generator 128 from the options data 112) on to a particular implant site currently shown on the GUI 126. The concept engine 134 can in turn generate a corresponding concept describing what the implant is and where it is being implanted in response to the user interactions. Continuing with the example of planning a surgery, different options can be provided as GUI elements, which can be selected (e.g., by the tool manager 130) according on the current step in the procedure. The options further can depend on the type of surgery and patient condition, such as can be ascertained from the patient data 110 and other user inputs.

As a further example, the tool manager 130 can include an episode generator 137 that is utilized to track and maintain the longitudinal episode data 132 for a given patient episode. For example, the episode generator 137 can create a new episode record in the longitudinal episode data 132 in response to a user input selecting an option to start a new episode for a given patient. If the episode already exists, new concept data can be appended to the existing record. The types of data that are maintained and stored in the longitudinal episode data 132 can vary depending upon the type of episode and the context of a given procedure.

By way of further example, the tool 102 can be utilized to generate a plan for a given procedure. In constructing a plan for a given procedure, the episode generator 137 can cause the GUI generator to select options that include pre-procedural testing or other interventions that may be desired prior to performing a subsequent procedure. Such options can be presented as GUI elements in the GUI 126, which can be selected or activated by a given user such as by dragging them into the procedure plan. Another option can include a free-form user input, such as can allow for dictation, typing or other form of input of one or more discrete concept. The types and details of such options can be stored in the options data 112. Once the user has completed the pre-procedure events and testing that may need to occur, a document generator 138 can generate a to-do list or other document that can be provided as part of the longitudinal episode data for a given course of management treatment. Additionally, the tool manager 130 may generate a scheduling message, such as for scheduling tests or interventions that may have been requested in such pre-planning. The scheduling message, for example, can be sent to a scheduling system (e.g., one of the external sources 120).

The tool manager 130 can also employ an EHR module 140 that can employ the interface 118 push corresponding interventions and requests that have been ordered back to the EHR system 116 to become part of a patient's permanent record. The type of information that can be pushed back to the EHR system 116 may vary depending upon the configuration and abilities of the EHR system. For example, detailed records can be provided in a desired format as specified by the EHR interface 118 for the destination EHR system. Alternatively, text records or PDF files can be generated at discrete points in the longitudinal episode and transferred to the EHR system 116, the extent of which can vary depending upon the ability of the EHR system.

The results of any testing can be entered into the tool 102 or retrieved from a data source, such as the EHR system 116 or one or more external sources 120, such as disclosed above. Additionally or alternatively, results can be entered directly into the tool 102 via the user input device 122.

As another facet of longitudinal care, the GUI generator 128 can also facilitate obtaining patient consent associated with a given procedure. The GUI generator 128 can create the GUI 126 to allow a user such as a provider to graphically demonstrate steps for an upcoming planned course of treatment and the tool manager 130 can store the corresponding concepts as the longitudinal data, such as disclosed above. The tool manager 130 can also include a consent generator 142 to generate a consent document, which may be electronic, a hard printed document or a combination of electronic and printed documents. The consent document can be generated from the same set of longitudinal data and the user interactions with the tool 102.

For example, during a meeting with the patient, a physician-user can employ a given user input device (e.g., a tablet compute or the like) and walk through individual steps of a given procedure. The GUI generator 128 can provide graphics via the GUI 126 to present a detailed visualization of the procedure, which can include animation, in response to the interactions with the GUI 126 by the physician-user. The GUI 126 can employ an anatomical visualization that can be modified in response to user interactions (e.g., via the input device 122) based upon the episode context data 108, options data 112, patient data 110 and user data 106. During this planning phase, the GUI generator 128 can present options as interactive graphical objects that can be moveable relative to anatomical graphics of the GUI 126. The concept engine 134 can thus create the discrete concepts in response to the demonstrative user interactions with the GUI, which collectively form a plan for a given procedure. After the various steps and options have all been reviewed and manipulated graphically via the GUI 126, each of the steps can be stored as discrete concepts as part of the longitudinal episode data 132.

The consent generator 142 further can generate a consent document. For example, the consent document can include the procedure plan demonstrated by the physician user to the patient, as indicated above. Alternatively, the consent generator 142 can provide consent document in other forms (e.g., graphical slide shows, PowerPoint, movies, printed documents, etc.), which can be acknowledged by the user. The user can indicate informed consent associated with each step of the procedure electronically via the user input device 122. This can be done after the demonstration by the physician or it can be done for each step during the procedure. Alternatively, consent document can be generated to capture the patient's informed consent in one or more other ways (e.g., handwritten signature). The consent document can also provide an indication of risk associated with the procedure, which also can be acknowledged by the patient.

In some embodiments, the tool manager 130 can also employ a prediction engine 144 to provide an indication of risk. The prediction engine 144 can be utilized to construct a risk based assessment for a given procedure planned by the user. For example, the prediction engine 144 can include a model selector 146 that is utilized to select a predictive model 148 which can vary depending upon plan that was generated as well as based on the patient data 110. The model selector 146 thus can select one or more predictive models depending upon the plan to provide an assessment of expected risk. For example, the risk generator can include a risk calculator 150 that can compute a corresponding indication of risk, which can be presented to the user. The indication of risk can also be presented to the patient such as within the consent document. The indication risk can be presented in a variety of formats, such as a percentage or other value that may be utilized to indicate a corresponding risk for a given type of procedure.

As mentioned above, the set of discrete concepts corresponding to a preoperative plan can be stored in the longitudinal episode data 132. The plan can be accessed for review, such as to understand what a given plan was. Additionally, the plan can be utilized in a subsequent course of treatment, such as for performing the planned procedure and generating a corresponding procedure note. If the plan is followed without deviation, the procedure plan can be utilized within the procedure along with entry of any additional details associated with the procedure that was performed. If a given user deviates from a plan, the changes can be made to the original plan and details added to provide the corresponding procedure note. A comparative note can be generated to identify differences between the pre-procedure plan and the procedure note. The additional details from the procedure and any differences between the plan and the actual performed procedure can be added to the longitudinal episode data 132. For example, the details can include a description of any implants that were utilized, notes on any unique aspects or complications as well as other comments and notes that may be desired to be entered to the procedure.

In one example, the same tool 102 can be utilized to generate the procedure note. Due to the longitudinal nature of the tool and the pre-procedure plan, the procedure note can be easily completed during or shortly after the procedure. In order to facilitate interaction with the tool 102, the user input device 122 may include a gesture recognition system that receives user inputs in response to gestures or hand movements relative to a sensing array (e.g., one or more cameras) in the operating room for real time capture of hand movements. Thus, the procedure note can be constructed via the tool 102 during or immediately following the procedure.

Following the procedure and entry of the procedure note, the EHR module 140 can push the note and other relevant information to the EHR system 116, similar to as disclosed above.

The tool 102 can also be utilized to facilitate post-procedure course of treatment and scheduling as well as generate discharge instructions for the patient. For example, the tool manager 130 can employ rules to select subsequent care options (corresponding to options data 112), such as for selecting medications, rehabilitation protocols, scheduling additional follow-up visits, and the like following the procedure. The rules can vary based upon the longitudinal episode data that has been stored for the procedure as well as preferences contained in the user data 106.

The tool 102 can also be employed to manage and document a post-procedure phase of the longitudinal care episode. For example, the document generator 138 can generate post-procedure instructions, such as while the patient remains admitted, as well a discharge instructions for the patient when discharged. This can be done automatically based on a post-procedure instance of the context data 104 for the given patient following procedure. Alternatively or additionally, the care instructions can be generated in response to a user input from the provider.

Since various aspects of the planning, the procedure and the like are stored as discrete concepts in the longitudinal episode data 132, the corresponding information can be leveraged to provide automated decision support. Additionally, due to the extent of the information that is stored as the longitudinal episode data 132, users can review such information via the tool 102 or via an application interface to the tool via another system (e.g., an EHR system) to obtain relevant essential patient care items for a particular episode that may not be as readily available or easily accessed via traditional mechanisms. The longitudinal data 132 thus can provide a detailed record of discrete elements that collectively represent various phases of a longitudinal care episode, including pre-procedure plan, an operative plan, consent information and post-procedure care. Corresponding data documenting each respective phase of longitudinal care can be stored in the EHR system 116.

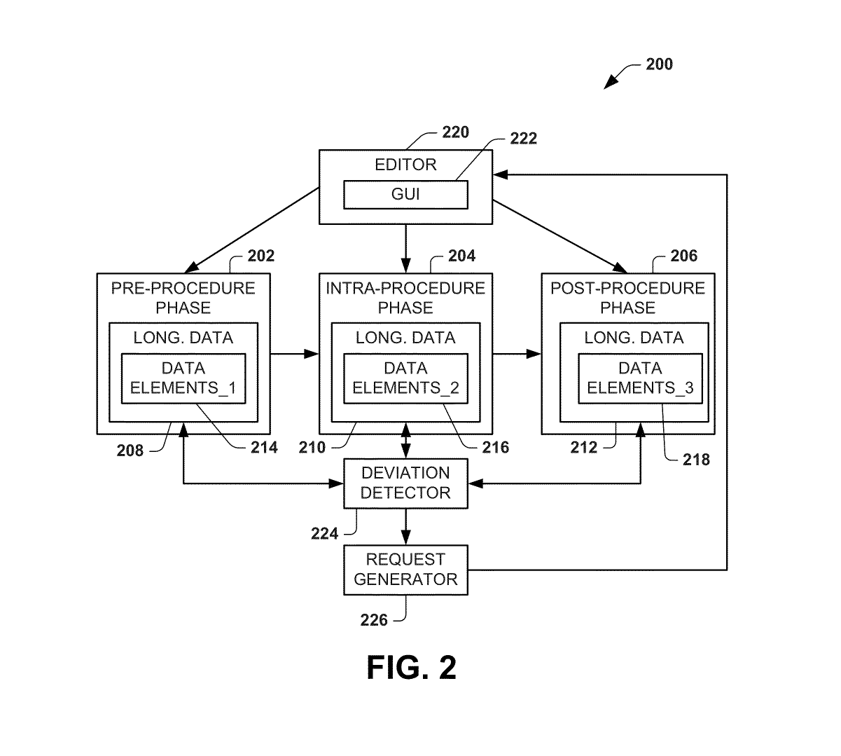

FIG. 2 depicts an example of a phase documentation management system 200 that can be implemented as part of the system 100 of FIG. 1. The system 200 is programmed to help maintain data consistency and facilitate tracking through multiple phases 202, 204 and 206 associated with a longitudinal care procedure for each patient. In the example of FIG. 2, the system 200 includes instances of a pre-procedure phase 202, an intra-procedure phase 204 and a post-procedure phase 206 associated with each respective patient. While three phases are demonstrated in this example, a longitudinal episode of patient care can be divided into different numbers of more or less phases, each of which phases can also include sub-phases. In some example, the pre-procedure phase 202 can be broken up into a pre-consult phase (e.g., corresponding to active problem list data), an initial consultation phase and a planning phase. Similarly, the post-procedure phase 206 may be divided into a pre-discharge sub-phase and a post-discharge subphase. Each such sub-phase can include respective data elements that reflect patient data (e.g., an active problem list) according to the available data for each such sub-phase, such as can be obtained from patient medical records, from the patient and from the provider.

Each phase 202, 204 and 206 includes longitudinal data 208, 210 and 212 that defines properties and attributes for each respective phase. In particular, the longitudinal data 208, 210 and 212 for each respective phase 202, 204 and 206 includes a plurality of data elements 214, 216 and 218 that collectively characterize a longitudinal health care episode. In some examples, the data elements 214, 216 and 218 can include coded data, such as ICD codes, CPT codes, SNOMED codes and the like for each phase. The coded data elements 214, 216 and 218 can be obtained from patient records (e.g., from an EHR system) and/or other data sources, such as disclosed herein. In some examples, a portion of the data elements can be provided by a health care provider user via an editor 220. For instance, the health care provider can interact with the system through corresponding GUI 222 of the editor 220 to add, modify or delete data elements for a given patient. Additionally or alternatively, the data elements 214, 216 and 218 can also include other types and forms of longitudinal patient data (e.g., the longitudinal episode data 132 and concept data 136 of FIG. 1) that can be derived from data acquired from a patient record and/or in response to a user input and other patient data sources.

The phase documentation system 200 also includes a deviation detector 224 to detect a deviation in longitudinal data between successive phases. For example, the deviation detector can compare data elements 214 of the pre-procedure phase 202 with data elements 216 of the next phase, namely, the intra-procedure phase 204. If the comparison identifies a discrepancy between data elements, such as corresponding to a change, deletion or addition that reflects an interphase deviation between adjacent phases of longitudinal care, the deviation detector 224 can trigger a request generator 226 to request additional information from the health care provider (e.g., via the GUI 222) about the detected deviation. In some examples, the precise content in the request can vary depending on the detected interphase deviation between phases 202 and 204 or 204 and 206.

As an example, as part of the intra-procedure phase 204, a care giver can accept the pre-procedure plan such that the data elements 214 from the pre-procedure phase 202 initially define and are stored as data elements 216 for the intra-procedure phase 204. During or after the procedure, a care giver or other user can employ the editor 220 to add, delete and/or revise one or more data elements 216 based on what transpires during the procedure. Some editing of the data elements 216 may also occur prior to the procedure, such as in a preparation stage of the intra-procedure phase 204. The deviation detector can be programmed to compare data elements 214 of the pre-procedure phase 202 with data elements 216 of the intra-procedure phase to determine if determined differences between such data elements are a type of discrepancy requiring explanation, and trigger the request generator 226 to request further details about the detected discrepancy. Alternatively, in situations where the differences between data elements 214 and 216 correspond to a level of specificity between otherwise consistent descriptors (e.g., data elements representing actions, equipment, services, diagnoses, and the like), the deviation detector 224 can allow the deviation to exist without triggering the request generator. The deviation detector 224 thus can be programmed to distinguish between a type of discrepancy that relate to a given category of a diagnosis or treatment that has changed from one phase to the next compared to a greater level of specificity between phases that remains consistent with an expected longitudinal standard of care.

As an example, where the data elements 214, 216 and 218 correspond to coded data elements, such as disclosed herein (e.g., ICD codes, DRG codes, CPT codes and the like), having a plurality of digits in which a most (or least) significant portion of the digits relate to a general category descriptor and a remaining portion of the digits relate to further specificity (e.g., location, anatomic site, etiology, approach, equipment used, etc.), the deviation detector 224 can be programmed to allow changes and additions to the portion of digits that describe greater specificity without triggering a request for information. Alternatively, the deviation detector 224 can be programmed based on rules (e.g., logic) that allow for certain changes in the category descriptor digits, certain particular (predetermined) changes in the specificity descriptors or both without triggering the request generator to request additional information. Such non-discrepant detected changes generally are not of the type in which the code in a subsequent phase is within an expected change, but instead demonstrate a greater amount of change than would be expected to maintain consistency. The amount of change and specific changes that can be detected as being discrepant can be programmable (e.g., in response to a user input), such as based on institutional or other standards. As yet another example, the deviation detector 224 can be programmed based on rules that to detect certain changes in the category descriptor digits, certain (e.g., predetermined) changes in the specificity descriptor digits or both that will result in triggering the request generator to require user input of details relating to each such change.

As a further example, the deviation detector 224 can be programmed to select a subset of digits from the coded data elements (e.g., a predefined most significant set of digits corresponding to category descriptors) 214 of the pre-procedure phase 202. The deviation detector 224 can employ the selected subset of digits as a template in which the remaining digits of respective coded data elements (corresponding to greater specificity descriptors) operating as ‘don't care’ values that can be applied to corresponding data elements 216 of the intra-procedure phase 204. For instance, in ICD-9, the first three digits can be employed as the template where the remaining two digits operate as don't care fields. In data elements coded according one of the ICD-10 standards, the first three or four digits (e.g., the heading of a category of codes) can be utilized by the deviation detector 224 as a template with the remaining three or four digits, which provide greater detail can be don't care values that are applied to the usually more detailed data elements 216 in the subsequent phase 204.

By way of example, if as part of plan, corresponding to the pre-procedure phase 202, a particular type of an implant was identified in the longitudinal data 208 (e.g., in one or more data elements 214) and a different implant is actually implanted and/or implanted at a different location during the intra-procedure phase 204, such as specified in longitudinal data 210 (e.g., in one or more corresponding data elements 216), the deviation detector 224 can compare the underlying data elements (e.g., procedure coded data) and determine if a discrepancy exists based on the comparison. If a discrepancy exists, the deviation detector 224 can trigger the request generator 226 to present the request to a user via the GUI 222. The GUI 222 can provide the request to the user for entering an explanation of why a different implant was used. The GUI 222 can store the explanation in memory in response to a user input, which, for example, can be added as notes (e.g., as a text field) that is programmatically associated with the corresponding data element that was determined to be discrepant. The request generator 226 can be programmed to issue a corresponding request in real time (e.g., as a pop-up window) each time the deviation detector determines that a discrepancy exists. Alternatively, the request generator 226 can be programmed to issue a corresponding request in real time (e.g., as a pop-up window) for providing additional details for each of a plurality of different interphase discrepancies, as determined by the deviation detector 224, after the latter phase has ended (e.g., in response to a user input).

It will be understood that longitudinal data 210 for the intra-procedure phase 204 can be updated in real time or near real time during the procedure, such as by one or more other data sources (e.g., an inventory tracking system, an anesthesia monitoring system or the like) that can be implemented within an operating room. Such other data sources can be interfaced to the system 100 of FIG. 1 and, by extension, to the system 200 via corresponding application interfaces (APIs). Corresponding data elements 216 thus can also be updated (e.g., new data elements can be added and existing data elements can be deleted or revised) based on information from these other data sources as well as information entered by a user, such as via the editor 220. When the data elements have been updated, the update can activate the deviation detector or the detector may run continuously as a background process, for example. As disclosed herein, the data elements can correspond to patient episode data that are stored in an EHR. Thus, in response to updates being made to one or more data elements, such updates can be pushed to the EHR system (e.g., the EHR system 116 of FIG. 1).

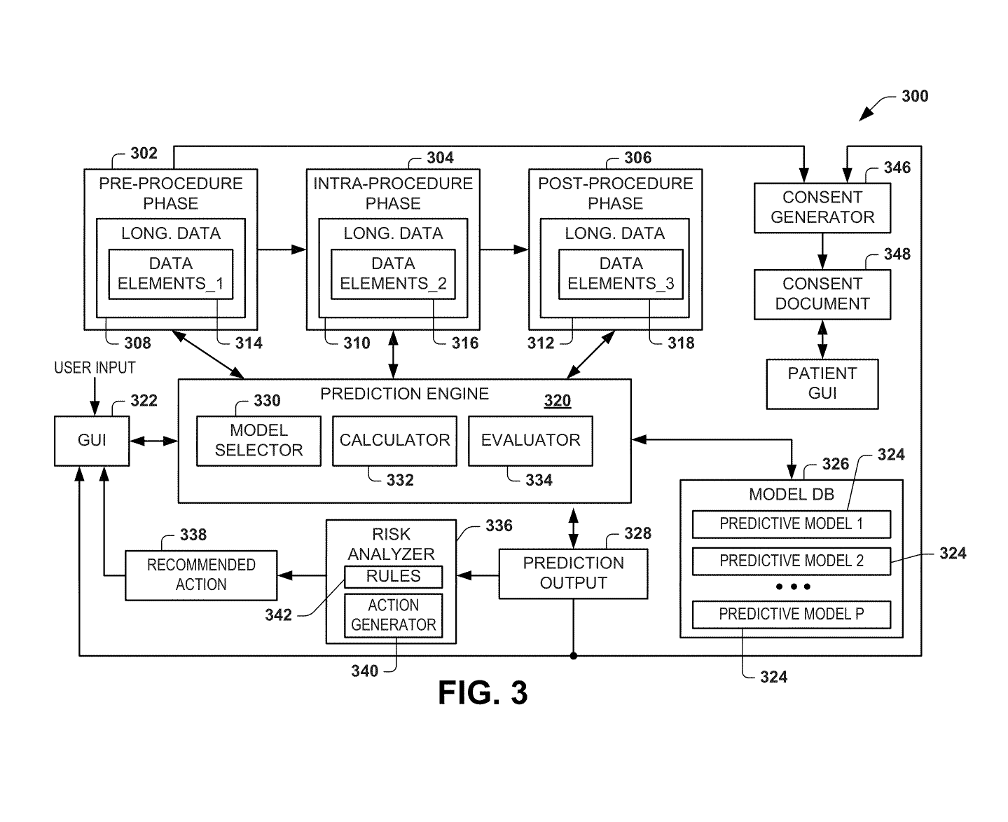

FIG. 3 depicts an example of a prediction system 300 that can be implemented in conjunction with various phases of the longitudinal care system 100 of FIG. 1. The prediction system 300 is programmed to help predict outcomes and risks associated with each of multiple phases 302, 304 and 306 associated with a longitudinal care procedure. In the example of FIG. 3, for sake of consistency, the phases 302, 304 and 306 are demonstrated as being substantially identical to phases in the example of FIG. 2. Briefly stated, the system 300 includes a pre-procedure phase 302, an intra-procedure phase 304 and a post-procedure phase 306. Each phase 302, 304 and 306 includes respective longitudinal data 308, 310 and 312 that contains a plurality of data elements 314, 316 and 318 that collectively characterize the longitudinal health care episode. In some examples, the data elements 314, 316 and 318 can include coded data, such as disclosed herein with respect to FIG. 2. For instance, the data elements utilized by the prediction engine in computing a prediction output can include problem list data elements at a given phase of the longitudinal care, including co-morbidities, patient conditions, diagnoses, medications and the like, such as can be obtained from an EHR system (e.g., the EHR system 116 of FIG. 1).

The system 300 includes a prediction engine 320 that is programmed to compute one or more prediction outputs 328 for each phase 302, 304 and 306 of the longitudinal care episode for the given patient. The prediction engine 320 can be programmed to compute a prediction value by applying one or more selected predictive models 324 to phase data elements 314, 316, 318 for the given patient. The same predictions can be performed for each of the respective phases based on a common set of models 324, but updated according to the available longitudinal data 308, 310 and 312 for each phase. In other examples, the predictions at each phase 302, 304 and 306 can be different, such as according to an independently selected set of models 324 for each respective phase, such as in response to a user input via a GUI 322. For example, a first set of prediction outputs 328 can be computed for the given patient at admission, such as based on the longitudinal data (e.g., patient data elements) available at admission. One or more additional predictions can be computed during each phase 302, 304 and 306 based on the longitudinal data, such as in response to collecting additional context data and/or in response to a user input activating the prediction engine to select one or models to predict respective outcomes and/or risks.

As a further example, each model 324 can include a set of predictor variables, corresponding to a predetermined set of data elements, and coefficients determined to forecast a likelihood of a particular outcome for which the given model has been generated. Data elements 314, 316 or 318 for a respective phase thus can be input to a given model to compute the prediction. As mentioned above, the data elements 314, 316 or 318 can correspond to problem list data elements for a respective phase. The greater match between the available data elements 314, 316 or 318 and the predictor variables in the selected model(s) 324, the greater the accuracy of the computed prediction output 328. In some examples, the predictive variables can correspond to subsets of available data elements 314, 316 and 318 that provide the longitudinal data 308, 310 and 312 for each respective phase 302, 304 and 306. The predictive models 324 can be stored in a database or other data structure demonstrated at 326. In other examples, models can be distributed across a network and accessed by the system 300 implementing appropriate interfaces to afford access to the distributed models.

In the example of FIG. 3, the prediction engine 320 includes a model selector 330 to select one or more predictive models 324. There can be any number of predictive models 324. The model selector 330 can select one or more of the predictive models 324 according to application requirements and the types of outcomes that may be desirable to predict. Examples of some relevant outcomes can include patient length of stay (LOS), patient satisfaction, patient diagnosis, patient prognosis, risk of major complications, risk of minor complications, mortality risk, readmission risk, patient resource utilization or any other patient outcome information that may be relevant to a healthcare provider, the patient or a healthcare facility. The prediction engine 320 can also compute outcomes or risks specific to a given patient's circumstances, such as including risks for procedural based complications, that can be identified based on longitudinal data 308, 310, 312 for a given phase 302, 304 or 306. There can also be a plurality of instances of a given model for predicting a particular outcome, each of which instances can vary depending on the input data elements 314, 316, 318 for a given phase of the patient's longitudinal care episode. Thus, the model selector 330 can select and configure a model 324 (e.g., with weighting and coefficients) based on the available set of data elements.

A calculator 332 can compute a prediction output 328 for each selected model based on the data elements 314, 316, 318 input to the model instance. The resulting prediction output 328 can be stored in memory. In some examples, each prediction output can also be stored as a data element of the phase 302, 304 and 306 for which it has been computed. Each prediction output 328 that is computed can become part of documentation that is stored in the patient record utilized for a respective phase of longitudinal care. Thus, a retrospective review of a longitudinal care episode can include an evaluation of associated data elements as well as prediction outputs that were computed.

The prediction engine 320 can also include an evaluator 334 programmed to evaluate the prediction output 328. For instance, the evaluator 334 can compute an accuracy measure, such as the concordance index or a confidence value, for each prediction output 328. The computed accuracy measure can provide evaluation data for the prediction, which can be provided as part of the prediction output 328. The prediction output 328 including the computed evaluation thereof can be presented to the user along with the prediction output via the GUI 322. Each prediction output, including its evaluation, can also be stored in memory as a data element of the phase 302, 304 and 306 for which it has been computed, which can be provided to and stored as part of the patient record (e.g., in the EHR system 116 of FIG. 1).

The system 300 can also include a risk analyzer 336 that is programmed to determine one or more recommended actions 338 based on the prediction output (e.g., including a predicted outcome and the associated accuracy measure) individually or in aggregate. The risk analyzer 336 can include an action generator 340 that is programmed to determine risks based on the prediction output and depending on the risk automatically generate a recommendation 338 for a relevant consultation and/or an order set (e.g., for one or more labs or other tests). An indication of the recommended action 338 can be presented to the user via the GUI 322. The user can accept (e.g., approve) the recommendation in response to entering a user input via the GUI 322, for example. For example, a consultation to a cardiologist can be recommended and approved via the GUI 322 if the prediction output indicates a sufficient likelihood of cardiac issues within a predetermined confidence threshold. In response to an authorized user input responsive to recommended action, documentation of the approval or disapproval can also be stored in memory as a new data element in the respective phase of longitudinal care. Such documentation can further be provided to the patient record (e.g., in the EHR system 116 of FIG. 1). If a consult or order is approved and accepted, in addition to documenting its acceptance, the approval can automatically provide a request to a scheduling system to schedule such consultation. An accepted order set or prescription can also be automatically submitted to a prescribed lab or other corresponding facility (e.g., pharmacy) for execution consistent with the requirements of the accepted order. If no order set is available for automatically generation, a user can employ the GUI 322 to generate an order set or prescription request in response to a user input. The resulting order set and/or prescription can be stored in memory for recommendation as an order set in future predictions that present the same or approximately the same risk.

In situations where the a prediction output 328 cannot be computed with reasonable accuracy, the risk analyzer 336 can provide an output to the GUI 322 indicating that the system 300 cannot specify a risk level with a sufficient certainty. This can occur, for example, where a patient has a very rare condition such that an adequate sample population is not available to generate an acceptable model. The output that is provided can be stored in memory as part of the data elements 314, 316, 318 for documenting the respective phase 302, 304, 306 of longitudinal care for the given patient. The stored output can also be stored in the patient record (e.g., of the EHR system 116 of FIG. 1) to document the circumstances related to the inability to compute a suitable risk assessment.

The prediction output 328 and results from the risk analysis can also be utilized by a consent generator 346 (e.g., corresponding to the consent generator 142 of FIG. 1) in generating a patient consent document 348 for a planned procedure based on the pre-procedure phase 302. As mentioned above, a consent document 348 is not limited to a plain text printed document, but can also include an electronic document, such as one or more webpages (e.g., generated according to a mark-up language like HTML or the like). As such, the document can include links (e.g., URLs or other resource locations) to detailed information, images and/or videos, which can be selected specifically from a data library and assembled for a given patient based on the patient's longitudinal data 314 of the pre-procedure phase 302.

Additionally, the prediction output 328 for each of one or more predictive models that are computed for the pre-procedure phase 302 can be included in the consent document 348 that is generated. As disclosed herein, the consent generator 346 can construct the consent document 348 in response to a user input based on a set of data elements, including those derived from an in-person step-by-step pre-procedure consultation between a healthcare provider and the patient. Such consultation can thus employ the graphical tool (e.g., the graphical tool 102 of FIG. 1) to as well as based on the patient's active problem list, relevant lab results, and the like. Since the consent document is generated based on longitudinal data 308 for a given patient (which can be based on the context data 104 and in response to user interactions with the GUI 126 of FIG. 1), the resulting consent document 348 and related prediction outputs 328 can be customized for the given patient based on the unique set of data elements (e.g., active problem list data) 314 for such patient. As disclosed herein, the data elements 314 that drive the pre-procedure phase of the longitudinal care episode, which forms part of the patient record, also provide a complete and accurate input data set based on which the consent generator 346 also constructs the consent document 348.

In addition to the consent document being stored in memory (e.g., as data elements 314) and forming part of the patient record for the pre-procedure phase 302, the patient or an individual (e.g., family member) acting on the patient's behalf can also interact with the consent document via a patient GUI 350. The longitudinal data responsive to user input interactions with the consent document via the GUI 350, including viewing each of a plurality of pages (e.g., webpages), can be stored in memory as context data elements 314 for the phase 302 and/or can be stored into the patient's record in an EHR system. The data responsive to the user input interactions can include data identifying that a given page was viewed, when it was viewed, an amount of time of such viewing, as well as other interactions with the document 348. To further document the viewing of the consent document 348 and related user interactions with the information presented in the consent document, an acknowledgement of content presented in pages or paragraphs, viewing of videos and images, can also be recorded in response to user inputs. A corresponding printed version of the consent document 348 can also be generated, which can include a signature line to provide a written acknowledgement of the patient's understanding of the procedure plan and risks involved with the planned procedure. Data associated with printing the document can also be stored as part of the associated longitudinal data, such as corresponding to an informed consent phase of the longitudinal patient care episode.

One or more portions of the consent document for the procedure plan can include or be derived based on interactions by the healthcare provider with the GUI. As disclosed herein, for example, the provider-user interactions can correspond to discrete concepts that are converted to longitudinal episode data that are stored as the data elements 314 for the pre-procedure phase. Thus, as the provider explains the procedure in a step by step graphical manner via the GUI, the corresponding concepts and selected options can be converted to longitudinal care episode data elements that are presented graphically to the patient in real time during the consultation. The resulting longitudinal episode data elements 314, which are stored in memory, can be accessed by the consent generator 346 to construct the consent document 348 directly from the stored data elements, such as disclosed. As a result, the consent document 348 is derived, at least in part, based on the same data elements 314 that were generated during the pre-procedure in-patient consultation in response to the provider interactions (e.g., concepts converted to patient-specific longitudinal care elements).

In addition to the application of the prediction engine to the pre-procedure phase 302 as mentioned above, the prediction engine 320 further can be programmed to compute predictions (e.g., for selected outcomes and risks) for the other phases 304 and 306 of longitudinal care episode. In some examples, some or all of the pre-procedure phase predictions can be updated, periodically (e.g., each day after admission, every 4 hours) or in response to the obtaining new or updated health care data for the patient (e.g., new tests, trends among tests, and the like). Additionally, the prediction engine 320 can be programmed to compute predictions as the patient transitions from one phase to the next phase, such as from pre-procedure to procedure phases or from the procedure to the post-procedure phase. As mentioned above, the models and prediction outputs that are computed can be preselected set of predictions selected based on longitudinal data and related context data at each phase. Additionally or alternatively, one or more predictions can be executed dynamically in response to a user input, such as a provider invoking the prediction engine to predict a selected outcome or risk for a given patient. Each of the prediction outputs can be stored in memory as corresponding data elements for a given phase of longitudinal care, which can also be stored as part of the patient's record (e.g., in the EHR system 116 of FIG. 1).

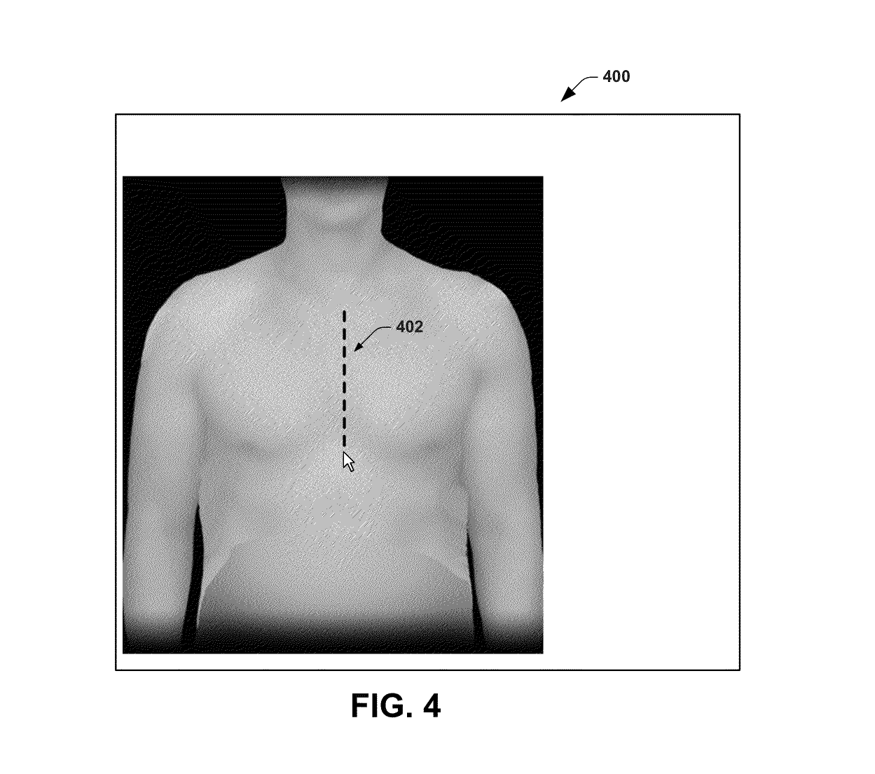

In order to provide additional context for the examples disclosed in relation to the systems and functions of FIGS. 1-3, FIGS. 4-20 provide an example of a GUI (e.g., the GUI 126 of FIG. 1) for demonstrating an approach that can be used to generate a procedure plan, such as part of a pre-procedure phase of a longitudinal care episode. The examples of FIGS. 4-20 provide a simplified example in the context of cardiac surgery, namely heart valve replacement. The approach demonstrated in FIGS. 4-20 is an example that can be generated in response to user interactions with GUI objects, such as can be part of an in-patient consultation between the provider and patient. Accordingly, patient interactions can be stored as part of the informed consent phase of the longitudinal care episode. It will be understood and appreciated that the systems and methods disclosed herein are by not limited to this example or to the example of a surgical procedure plan. For instance, the systems and methods disclosed herein can be applied to other types of surgery and are further equally applicable to facilitate managing and documenting longitudinal care episodes for any type of medical treatment procedure, including in-patient and/or out-patient care. Additionally, as disclosed herein, each user interaction with the GUI of FIGS. 4-20 are converted to corresponding concepts, which can include a narrative or descriptive text, graphics and the like, associated with a patient's longitudinal care episode. The discrete concepts provided in response to each user interaction via the GUI can be stored in memory as data elements for a given phase of the patient's longitudinal care episode, which data elements further can be pushed to an electronic health record for the patient.

FIG. 4 depicts an example GUI 400 showing a representation of a thoracic cavity. A line 402 demonstrate the concept of an incision for a sternotomy, such as can be drawn on the GUI 400 and dynamically represented at a desired location in response to a user input entered via an input device (e.g., touch screen, mouse or the like). In addition to displaying graphically the incision, corresponding coded data element for such discrete concept can be stored in memory as disclosed herein.

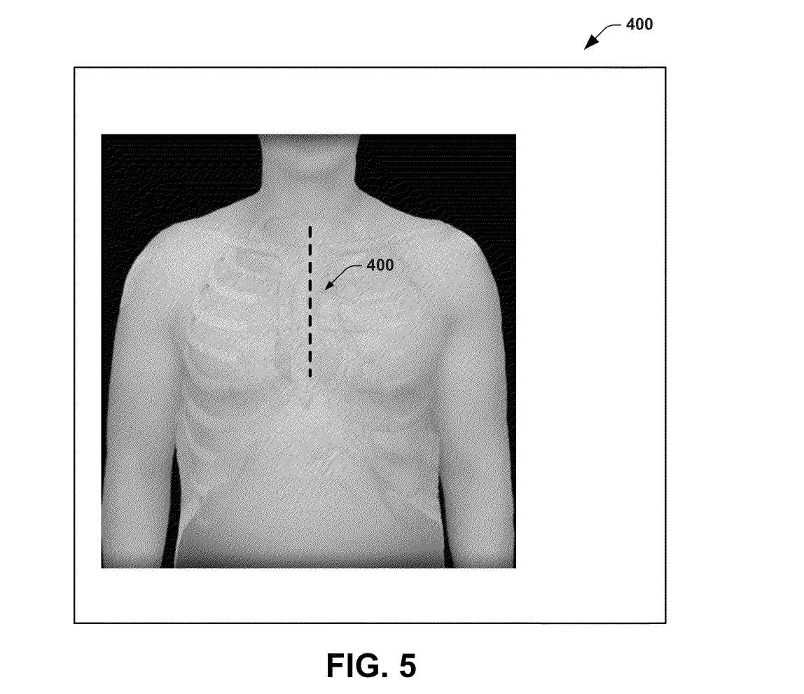

FIG. 5 demonstrates some internal anatomical structures that can represented on the GUI 400 in response to the user input corresponding to the incision. The internal anatomical structures near the incision line 402 can be general for all patients or include a context driven set of anatomical structures based on patient data elements.

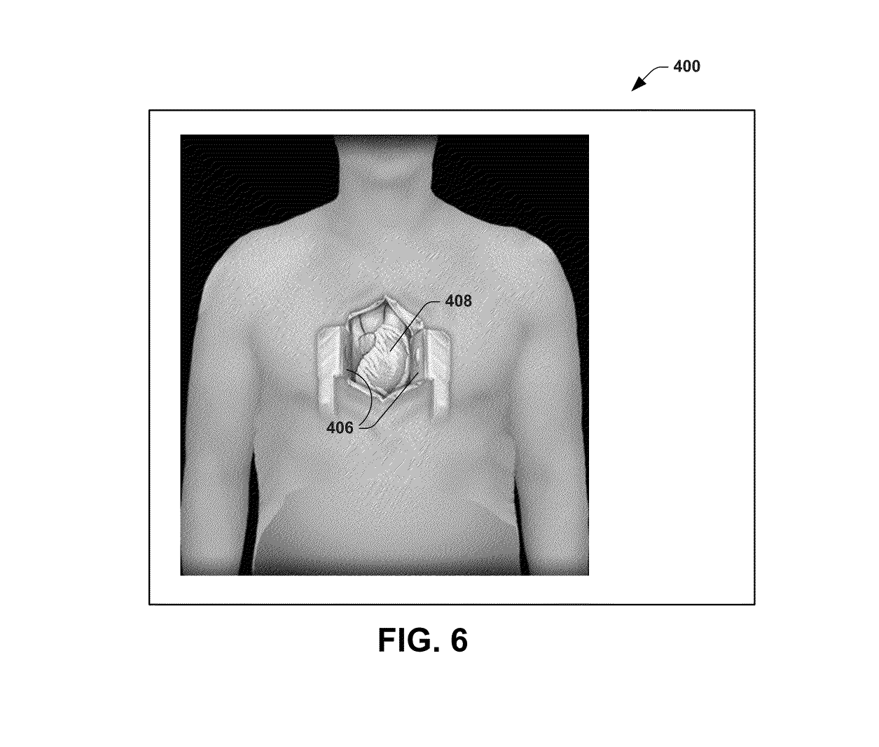

In FIG. 6, as part of the sternotomy, the sternum is shown divided (or “cracked”) by demonstrating access to a representation of the heart for the surgical procedure. The transition in the GUI from FIG. 4 to FIG. 6 can be animated over a plurality of frames, for example. In addition to displaying the sternotomy graphically, corresponding coded data elements for this approach (e.g., an ICD-9-CM, ICD-10 or CPT code) can also be stored in memory associated with this part of the procedure.

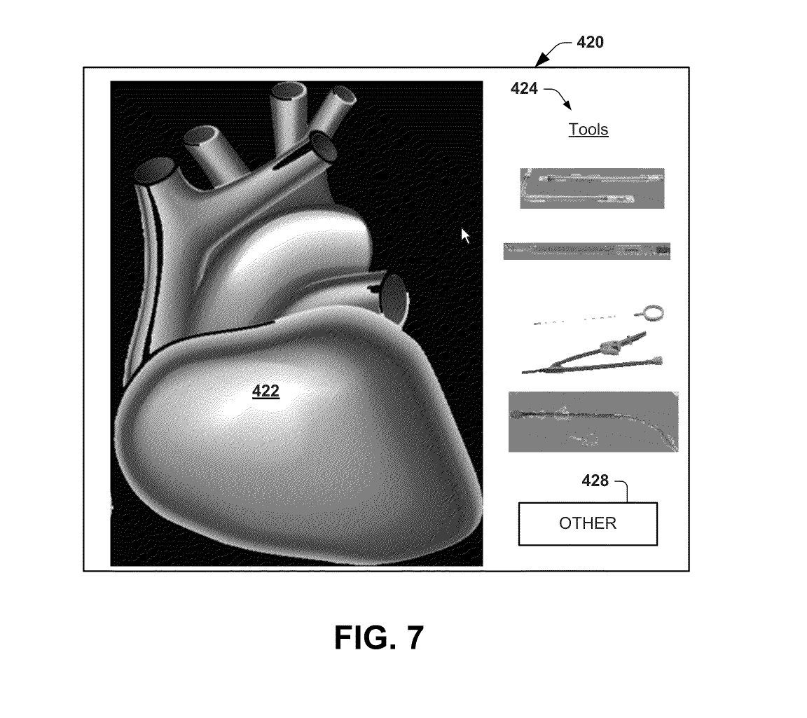

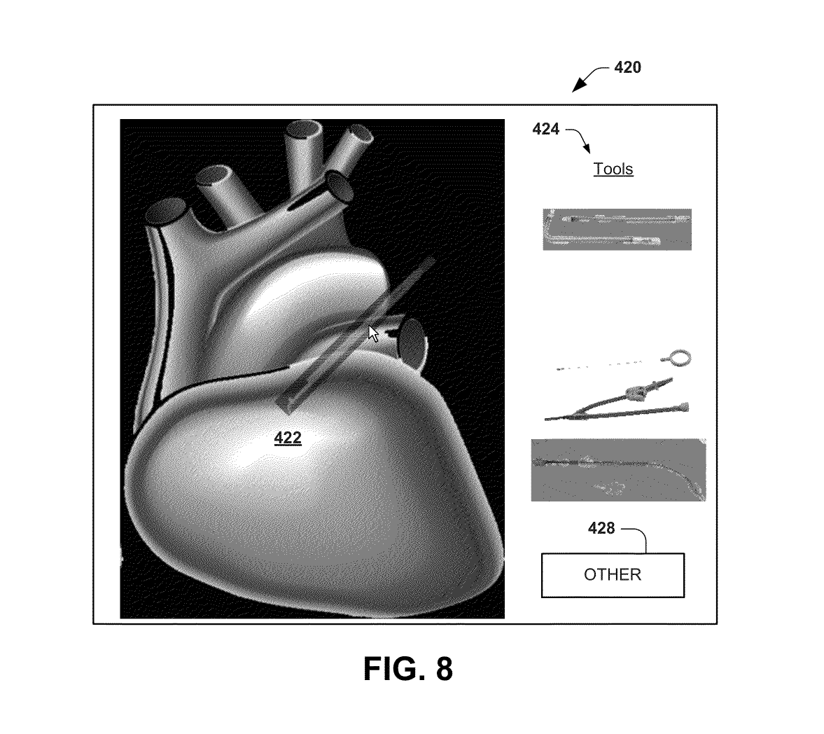

Since in this example the procedure is to include heart valve replacement (e.g., as reflected in episode context data 108 and related concept data 136 of FIG. 1), following FIG. 6, the system can generate a GUI 420 that can include a graphical representation of the heart 422 along with a set of tools 424, as shown in FIG. 7. The tools can correspond to a set of options that can be selected for the given based on longitudinal data and provider preference data, as disclosed herein. Each of the tools 424 can be interactive GUI elements that can be manipulated in response to user input (e.g., via an input device) to perform an action relative to the heart. For example, in FIG. 8, a scalpel GUI element 426 can be selected, such as to simulated an expected approach for accessing the heart. If a desired tool is not shown in the GUI, an “other” options GUI element 428 can be activated to provide a more extensive list of tools.

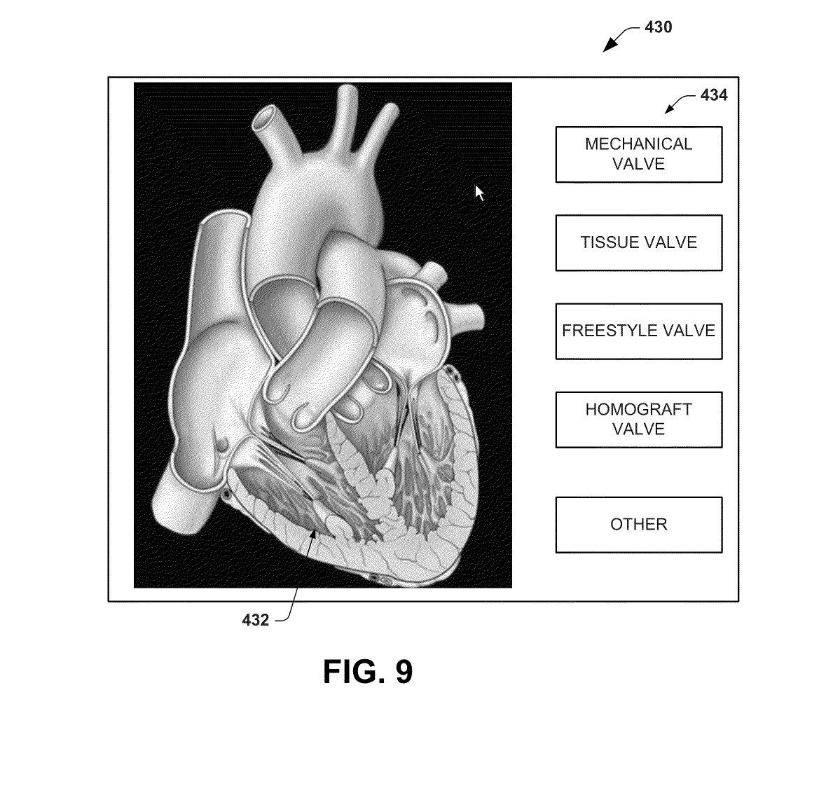

Following use of a selected tool, such as to access the heart or perform another part of a given procedure, a GUI 430 can be generated to include a sliced view of the cardiac anatomy 432 as demonstrated in FIG. 9. At this stage, a set of GUI elements corresponding to different valve types (e.g., mechanical, tissue, freestyle or homograft valves) 434 can also be provided on the GUI 430 as interactive objects. A user can select a desired type of valve by activating the GUI element for selected valve type, such as can vary depending on patient data and consultation with the patient, and position the selected valve at the desired implant site (e.g., the aortic annulus). The selection of a given valve type can further result in generating a corresponding coded data that can be stored in memory, such as to specify the type of valve, the implant position and other related descriptors for the user-selected approach. In some examples, additional expected details for the selected implant can also be elicited from the provider, such as the manufacturer, model number, size and the like. Such additional information can be sent to an inventory management system to help ensure that the selected implant and related equipment are in stock and available for the schedule procedure.

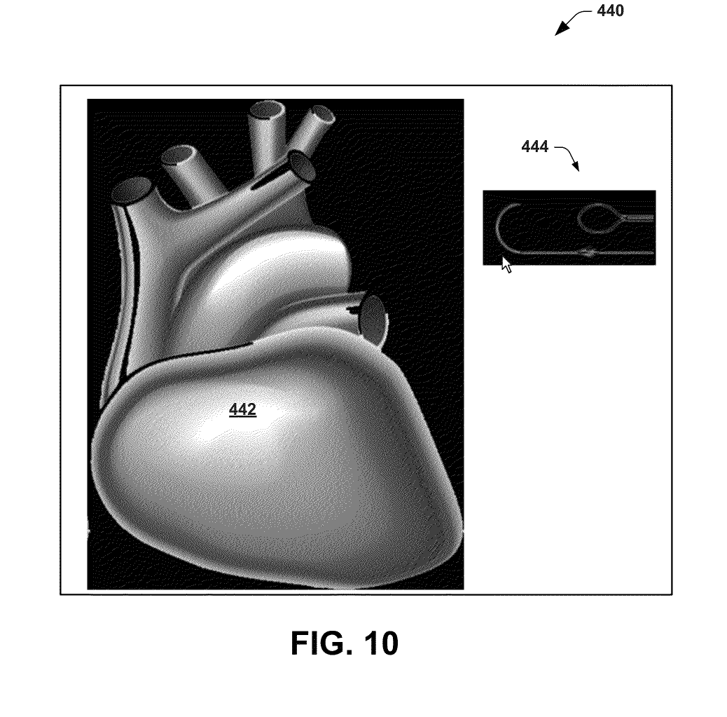

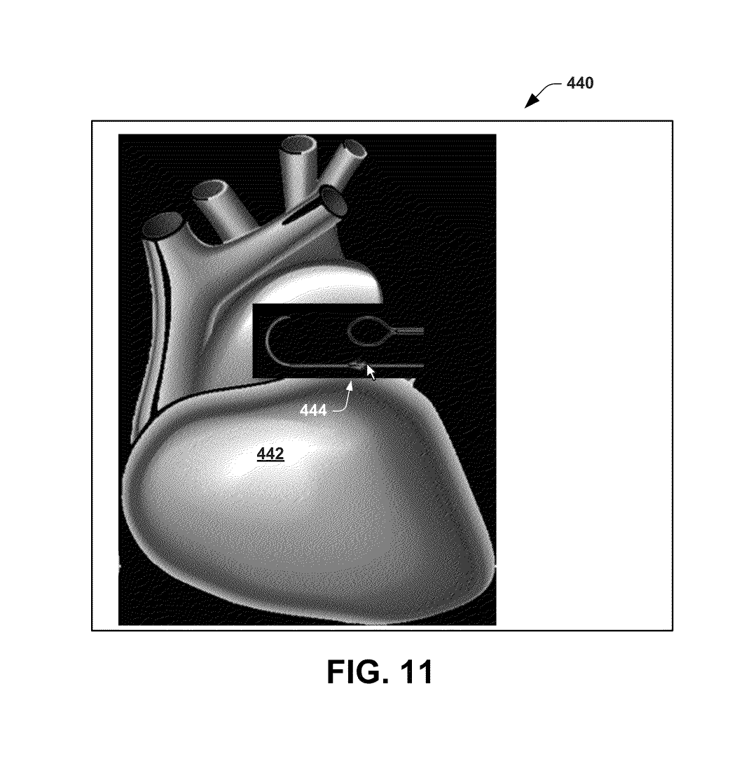

FIGS. 10 and 11 shows an example of a GUI 440 that includes a graphical representation of a heart 442 and one or more GUI elements 444 for tools, including a pacing wire, that can be selected in response to a user input. For instance, the pacing wire GUI element 444 that can be positioned on the heart to represent a concept for pacing the patient's heart as part of the planned procedure, such as at the sinoatrial node as schematically demonstrated in FIG. 11. Thus, as disclosed herein, the discrete concept of pacing can be determined in response to the graphical interaction of selecting and dragging a pacing lead onto the heart. This discrete concept is further used to generate a corresponding data element for the planned pacing the patient's heart (e.g., an ICD or CPT code) as well as one or more codes for the selected pacing lead and other related equipment that may be required to perform such part of the procedure.

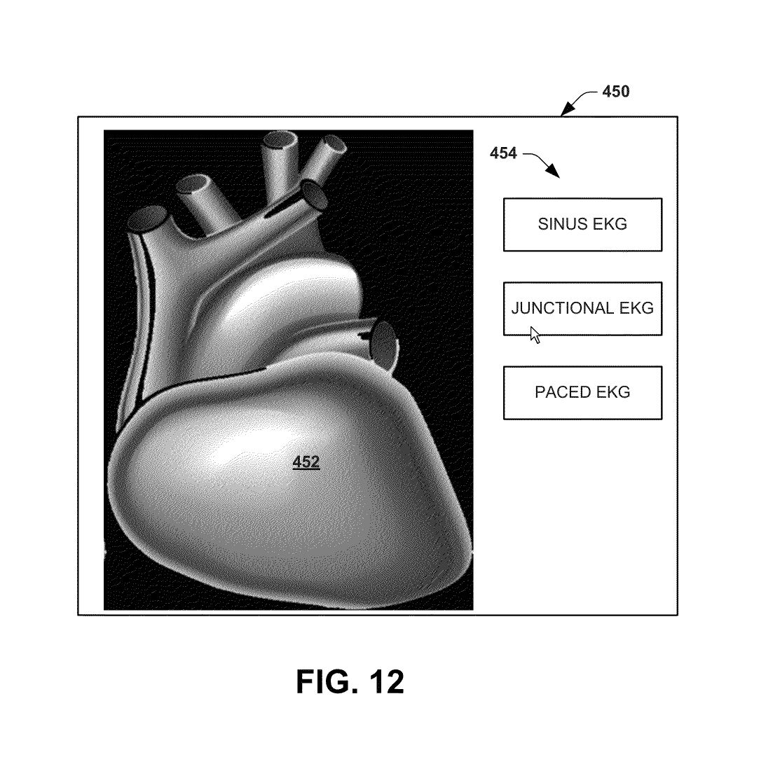

FIG. 12 demonstrates a GUI 450 that includes a graphical representation of the heart 452 as well as GUI elements 454 listing a set of options for different measurements that can be made during the procedure. In the example of FIG. 12, the GUI elements can represent different approaches to obtain a patients EKG. A user thus can select a planned measurement approach for the procedure in response to a user input, which user selection can also generate one or more corresponding coded data elements that specify the selected approach and equipment to perform the approach. The coded data elements can be stored in memory.

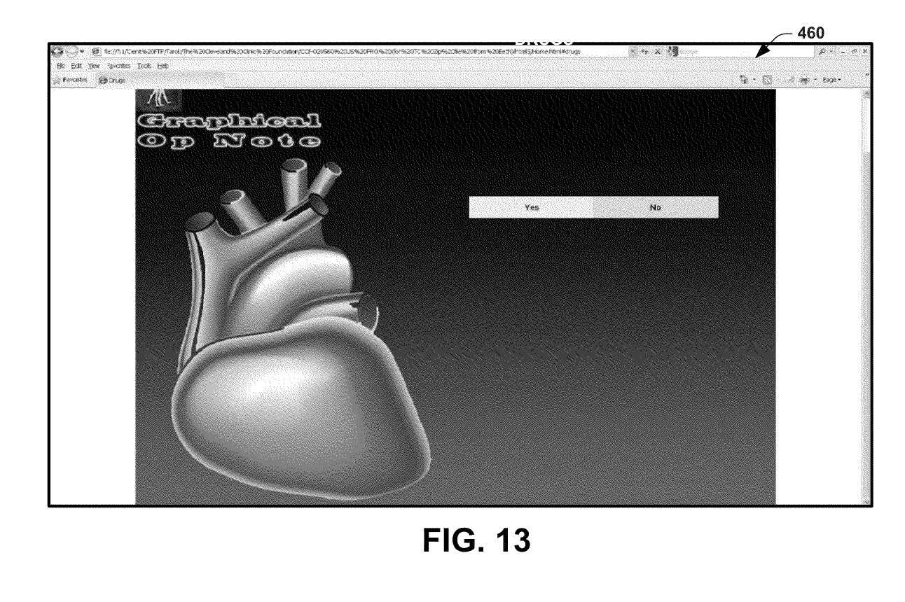

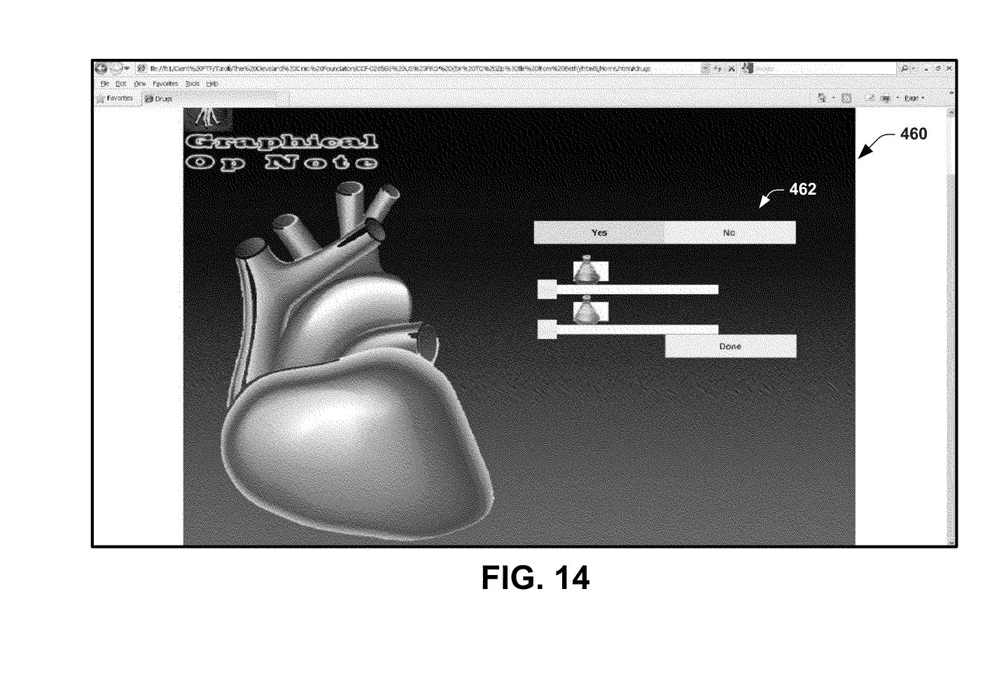

FIGS. 13 and 14 demonstrate a GUI 460 for that can be employed to select whether drugs are to be administered to the patient during the procedure. A user can select options in response to a user input. In FIG. 14, responsive to the user input at FIG. 13, the GUI 460 provides GUI elements 462 to identify one or more different types of drugs that may be used (e.g., selected based on user preferences). Expected dosage of each selected drug can also be specified by the user, if desired via an input GUI element 462 associated with the drug. If a given drug is desired but not shown, a user can input the desired drug in a user input dialog box or from a list of other options that can be provided in the GUI 460. One or more data elements can be generated and stored in memory for each drug that is selected along with documentation of its selection by the provider.

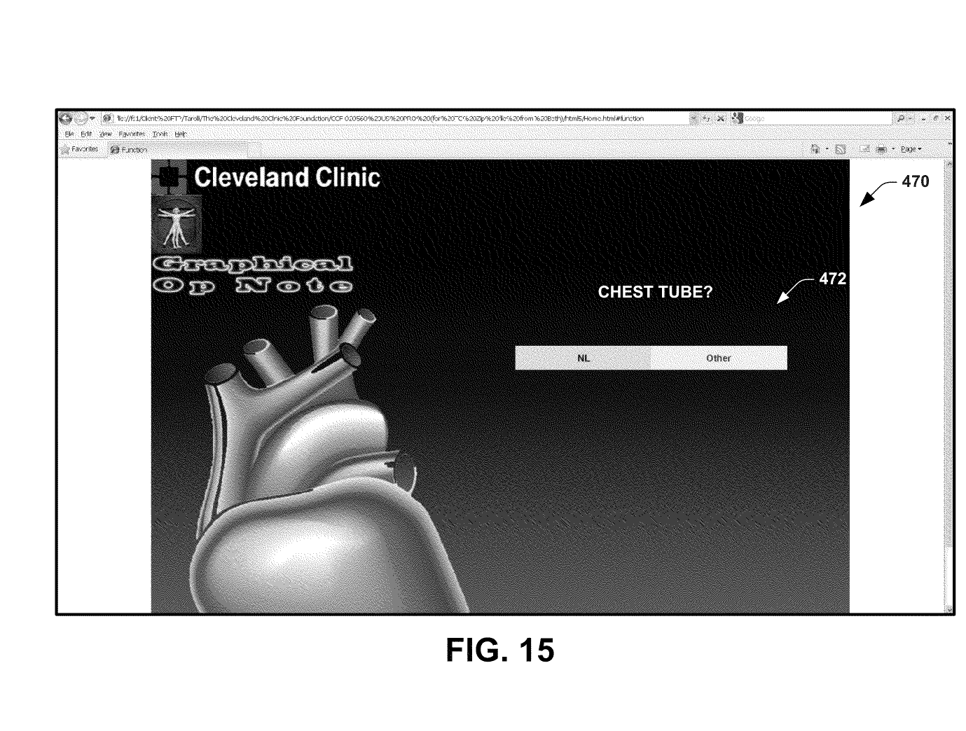

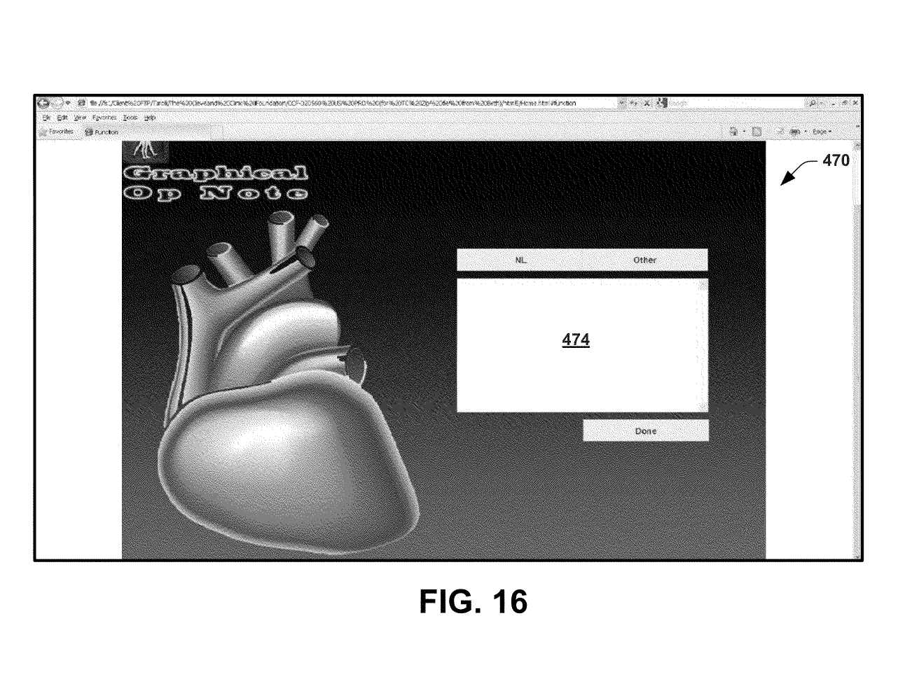

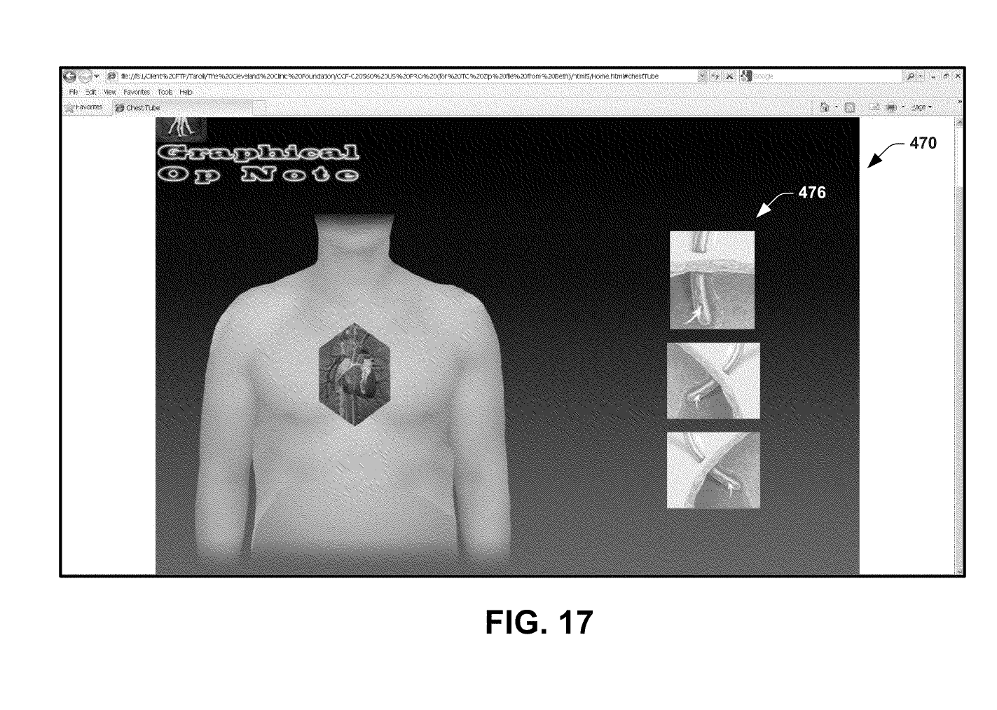

FIGS. 15-17 demonstrate different aspects of a GUI 470 that can be used for planning use of a chest tube as part of a procedure. In the example of FIG. 15, the GUI 470 includes GUI elements 472 that can be activated in response to a user input to select a type of chest tube, such as a standard type of chest tube (e.g., a native line (NL)) or one or more other types. As demonstrated in FIG. 16, for example, if a different type of chest tube is selected via the GUI element 472 (FIG. 15), the GUI 470 can provide a dialog box 474 for entering a corresponding free-form description (e.g., via keyboard or dictation). Information in the dialog box 474 can be parsed to determine details about the user's selected option, which can further be converted to a corresponding coded data element that is stored in memory associated with this part of the procedure plan. As demonstrated in FIG. 17, if the standard type of tube is selected in the GUI 470 of FIG. 15, the GUI can provide a set of GUI elements 476. A user thus can selected one of the GUI elements 476 to identify the desired type of tube, which selection can be converted to a data element representing the selected one of the different tube types (e.g., including a procedure code and one or more inventory code).

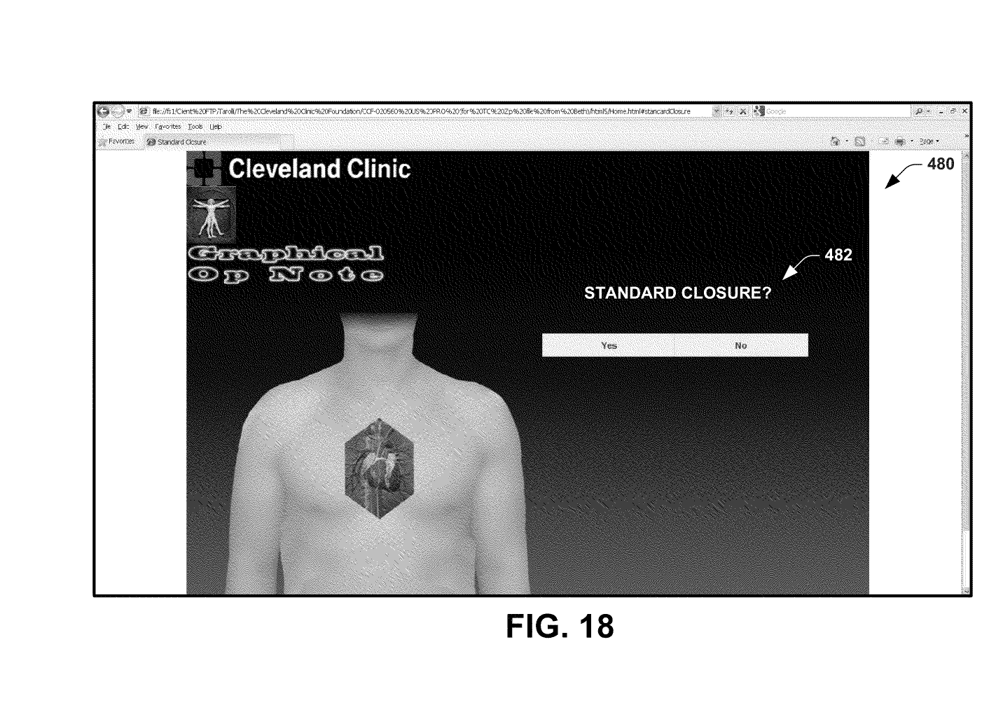

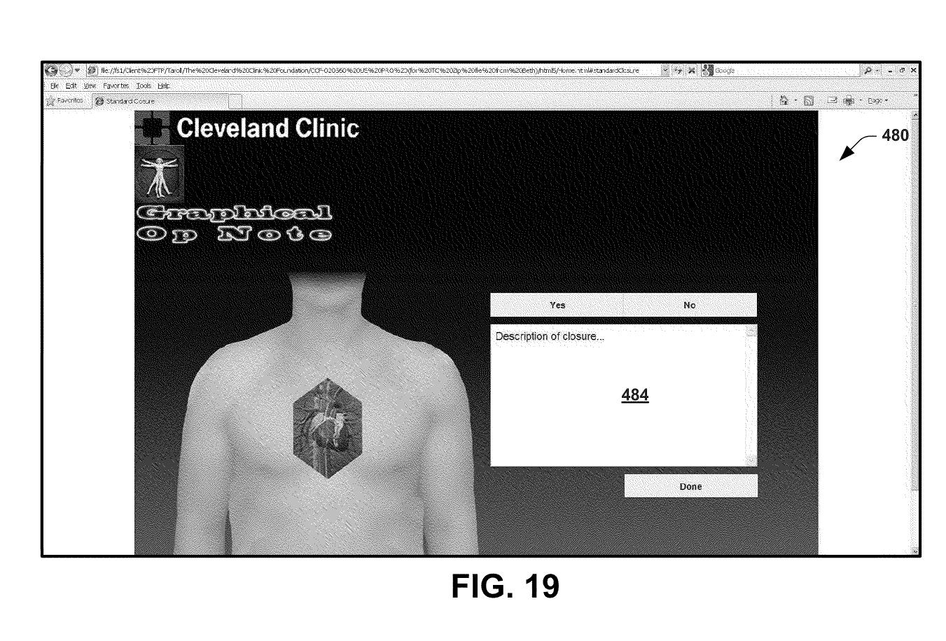

FIGS. 18 and 19 demonstrate a GUI 480 for planning a type of closure for the procedure. In the example of FIG. 18, the GUI 480 includes a GUI element 482 to select the closure type, such as a standard or non-standard closure. The type of closure options presented via the GUI can be selected based on longitudinal data disclosed herein, including for the patient and provider preferences, for example. If a non-standard closure is selected, the GUI can provide a dialog box or other user input mechanism 484 via which the user can specify the planned type of closure, such as shown in FIG. 19. The selection and other user inputs can be stored in memory as one or more data elements for the planned procedure.

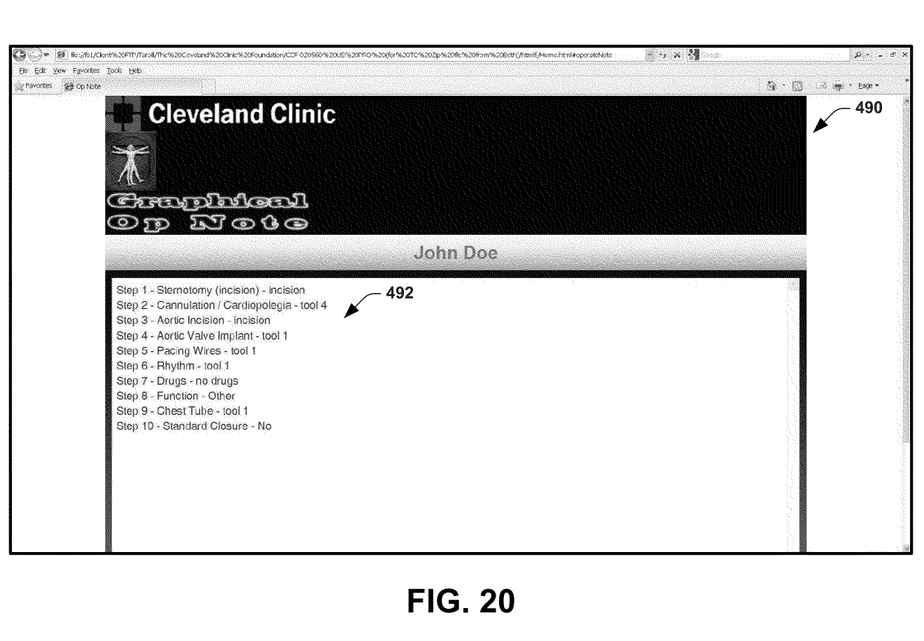

After the approach for the planned procedure has been completed (e.g., as demonstrated in FIGS. 4-19), the user can indicate so in response to a user input via the GUI to finalize the plan. Alternatively, the user can go back to any of the planned items and modify the selected approaches. Once the plan has been finalized by the user and accepted by the patient, the system can store the finalized plan in memory. As disclosed herein, this can include the various data elements (e.g., procedural and/or inventory codes) for the different part of the procedure. As an example, FIG. 20 demonstrates a GUI 490 that present a representation of the corresponding plan for the identified steps 492 of the procedure in response to the user interactions during the planning process. Each of the identified steps 492, for example, can be implemented GUI elements that can utilized to access graphics and/or video associated in response to a user selecting a respective. The pre-procedure plan and the associated data elements can also be stored in memory as part of the longitudinal care episode data (e.g., forming part of the pre-procedure phase). During the intra-procedure phase, the various steps can be accepted or modified to reflect the actual approach and equipment utilized during the procedure. As disclosed herein, deviations from the planned procedure can be detected (e.g., by the deviation detector 224 of FIG. 2) to invoke methods and function to collect explanatory data from the health care provider or related personnel about each deviation from the plan. Thus, the system helps to eliminate data inconsistency from one phase to the next by requiring that discrepancies be explained and form part of the patient's record for the longitudinal care episode.

Additionally, the pre-procedure plan can be utilized (e.g., by the consent generator 142 of FIG. 1 or 346 of FIG. 3) to generate a patient consent document, such as disclosed herein. The graphical representations and video images provided during the consultation can be part of the consent document. In some examples, the live patient consultation can be recorded and the recorded consultation (or an edited version thereof) can be provided as part of the consent document. Based on the plan data (including data elements for the approaches in the planned procedure and longitudinal patient data, such as coded patient data and other related patient context data), one or more predictions can be computed (e.g., by the prediction engine 144 of FIG. 1 or 320 of FIG. 3) and be incorporated into the consent document.

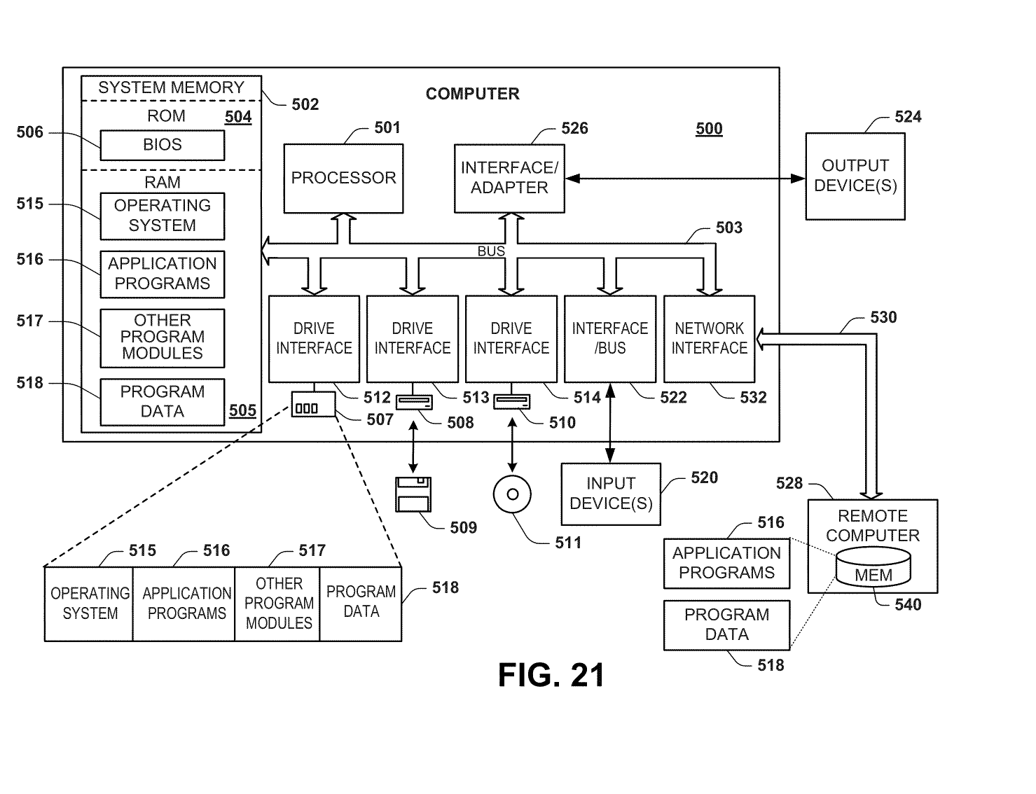

In view of the foregoing structural and functional description, those skilled in the art will appreciate that portions of the invention may be embodied as a method, data processing system, or computer program product. Accordingly, these portions of the present invention may take the form of an entirely hardware embodiment, an entirely software embodiment, or an embodiment combining software and hardware, such as shown and described with respect to the computer system of FIG. 21. Furthermore, portions of the invention may be a computer program product on a computer-usable storage medium having computer readable program code on the medium. Any suitable computer-readable medium may be utilized including, but not limited to, static and dynamic storage devices, hard disks, optical storage devices, and magnetic storage devices.

Certain embodiments of the invention have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In this regard, FIG. 21 illustrates one example of a computer system 500 that can be employed to execute one or more embodiments of the invention, such as including the graphical management tool and access to corresponding information and graphics generated thereby. Computer system 500 can be implemented on one or more general purpose networked computer systems, embedded computer systems, routers, switches, server devices, client devices, various intermediate devices/nodes or stand alone computer systems. Additionally, computer system 500 can be implemented on various mobile clients such as, for example, a personal digital assistant (PDA), laptop computer, pager, and the like, provided it includes sufficient processing capabilities.

Computer system 500 includes processing unit 501, system memory 502, and system bus 503 that couples various system components, including the system memory, to processing unit 501. Dual microprocessors and other multi-processor architectures also can be used as processing unit 501. System bus 503 may be any of several types of bus structure including a memory bus or memory controller, a peripheral bus, and a local bus using any of a variety of bus architectures. System memory 502 includes read only memory (ROM) 504 and random access memory (RAM) 505. A basic input/output system (BIOS) 506 can reside in ROM 504 containing the basic routines that help to transfer information among elements within computer system 500.

Computer system 500 can include a hard disk drive 507, magnetic disk drive 508, e.g., to read from or write to removable disk 509, and an optical disk drive 510, e.g., for reading CD-ROM disk 511 or to read from or write to other optical media. Hard disk drive 507, magnetic disk drive 508, and optical disk drive 510 are connected to system bus 503 by a hard disk drive interface 512, a magnetic disk drive interface 513, and an optical drive interface 514, respectively. The drives and their associated computer-readable media provide nonvolatile storage of data, data structures, and computer-executable instructions for computer system 500. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of the present invention.

A number of program modules may be stored in drives and RAM 505, including operating system 515, one or more application programs 516, other program modules 517, and program data 518. The application programs and program data can include functions and methods programmed to acquire, process and display electrical data from one or more sensors, such as shown and described herein. The application programs and program data can include functions and methods programmed to provide a graphically-based management tool for planning and recording longitudinal health care data.

A user may enter commands and information into computer system 500 through one or more input devices 520, such as a pointing device (e.g., a mouse, touch screen), keyboard, microphone, joystick, game pad, scanner, and the like. For instance, the user can employ input device 520 to edit or modify a domain model. These and other input devices 520 are often connected to processing unit 501 through a corresponding port interface 522 that is coupled to the system bus, but may be connected by other interfaces, such as a parallel port, serial port, or universal serial bus (USB). One or more output devices 524 (e.g., display, a monitor, printer, projector, or other type of displaying device) is also connected to system bus 503 via interface 526, such as a video adapter.

Computer system 500 may operate in a networked environment using logical connections to one or more remote computers, such as remote computer 528. Remote computer 528 may be a workstation, computer system, router, peer device, or other common network node, and typically includes many or all the elements described relative to computer system 500. The logical connections, schematically indicated at 530, can include a local area network (LAN) and a wide area network (WAN).

When used in a LAN networking environment, computer system 500 can be connected to the local network through a network interface or adapter 532. When used in a WAN networking environment, computer system 500 can include a modem, or can be connected to a communications server on the LAN. The modem, which may be internal or external, can be connected to system bus 503 via an appropriate port interface. In a networked environment, application programs 516 or program data 518 depicted relative to computer system 500, or portions thereof, may be stored in a remote memory storage device 540.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A system to manage a longitudinal care episode for a patient, comprising:
a patient data aggregator, executable by a processor, to provide context data for the patient, at least a portion of the context data including patient data associated with multiple phases of the longitudinal care episode;
a tool manager, executable by the processor, to translate user interactions with an associated graphical user interface (GUI) into corresponding discrete concepts, the corresponding discrete concepts being stored in memory as part of longitudinal episode data for the patient, the longitudinal episode data being generated based on the context data and in response to the user interactions with the GUI to facilitate documentation and management of the longitudinal care episode.

2. The system of claim 1, wherein the tool manager further comprises a concept engine, executable by the processor, to link programmatically the corresponding discrete concepts together in an ordered construct representing the longitudinal episode data throughout each of the multiple phases the longitudinal care episode.

3. The system of claim 1, wherein the longitudinal episode data comprises a plurality of data elements, data elements being linked together for each respective phase of the multiple phases of the longitudinal care episode.

4. The system of claim 3, wherein the plurality of data elements include a set of active problem list data elements for the patient.

5. The system of claim 3, wherein the plurality of data elements further comprise predetermined coded data elements, each of the coded data elements being programmed, according to a prescribed code standard, to represent a respective aspect of the longitudinal care episode for the patient.

6. The system of claim 5, further comprising a deviation detector, executable by the processor, to detect deviations and enforce consistency of the longitudinal episode data between successive phases of the multiple phases of the longitudinal care episode based on comparison of corresponding coded data elements thereof in the successive phases.

7. The system of claim 6, wherein the deviation detector compares a predetermined most significant subset of digits in a given corresponding coded data element in the successive phases.

8. The system of claim 6, further comprising a request generator, executable by the processor, to issue a request via the GUI, the request generator being triggered to issue the request in response to the deviation detector determining a discrepancy between the longitudinal episode data in the successive phases, a response to the request being stored as the longitudinal episode data in a latter one of the successive phases to remove the discrepancy between the longitudinal episode data in the successive phases.

9. The system of claim 5, further comprising a health record interface to access a health record system, the data aggregator employing the health record interface to obtain at least a portion of the coded data elements from the health record system, which are employed to generate the longitudinal episode data, the tool manager employing the health record interface to provide selected data elements from the longitudinal episode data to the health record system for documenting aspects for each of the multiple phases of the longitudinal care episode.

10. The system of claim 1, further comprising a prediction engine, executable by the processor, to compute a prediction output for at least one phase of the multiple phases, the prediction output being computed for each at least one phase based on at least one predictive model that is selected and the longitudinal episode data for each respective phase, the prediction output being provided to an associated health record system for documenting the prediction output and associated user interactions therewith in the longitudinal care episode of the patient.

11. The system of claim 10, wherein the data elements comprise predetermined coded data elements, each of the coded data elements being programmed, according to a prescribed code standard, to represent a respective aspect of the longitudinal care episode for the patient,
the prediction engine further comprising:
a model selector to select and configure the at least one predictive model based on the coded data elements stored for the at least one phase; and
an evaluator to evaluate the prediction output and assign an accuracy level to facilitate analysis of the prediction output.

12. The system of claim 11, further comprising a risk analyzer, executable by the processor, to generate recommended action data that is stored in memory based on the analysis of the prediction output and its associated confidence value, an interactive representation of the recommended action data being provided to a user via the GUI.

13. The system of claim 12, further comprising a health record interface to access a health record system, the data aggregator employing the health record interface to obtain at least a portion of the coded data elements from the health record system, which are employed to generate the context data, the tool manager employing the health record interface to provide selected data elements from the longitudinal episode data to the health record system for documenting at least one of the recommended action data or interactions with the interactive representation thereof for the longitudinal care episode.

14. The system of claim 10, wherein the at least one phase includes a pre-procedure phase of the multiple phases of the longitudinal care episode, the tool manager further comprising a consent generator to generate an interactive consent document based on the longitudinal episode data for the pre-procedure phase, and at least one prediction output computed for the pre-procedure phase, and a patient GUI to interact with the interactive consent document such that data corresponding to patient interactions with the patient GUI are stored in the longitudinal episode data for the pre-procedure phase.

15. The system of claim 14, wherein the longitudinal episode data for the pre-procedure phase includes a procedure plan that is generated, in response to user interactions with the GUI during the pre-procedure phase, by translating the user interactions with the GUI into the a set of the corresponding discrete concepts that define the procedure plan,
another phase of the multiple phases comprising an intra-procedure phase that includes intra-procedure longitudinal data derived based on the procedure plan from the pre-procedure phase.

16. The system of claim 15, wherein the intra-procedure longitudinal data comprises data elements, data elements of the intra-procedure phase comprising coded data elements, each of the coded elements being programmed, according to a prescribed code standard, to represent a respective aspect of the longitudinal care episode for the patients, the tool manager being programmed to detect a discrepancy between a coded element in the longitudinal episode data of the intra-procedure phase relative to a corresponding coded data element in the procedure plan from the pre-procedure phase, an indication of the detected discrepancy being stored as discrepancy data in the intra-procedure longitudinal data.

17. The system of claim 16, wherein the tool manager is further programmed to generate an interactive request based on the discrepancy data via the GUI, a response to the interactive request being stored in the intra-procedure longitudinal data as response data for documenting the detected discrepancy for the intra-procedure phase.

18. The system of claim 17, further comprising a health record interface to access a health record system, the tool manager employing the health record interface to provide the response data to the health record system for documenting the detected discrepancy in a health record for the patient.

19. The system of claim 18, wherein the data aggregator is further configured to obtain external data from at least one external source, other than the health record system, the external data providing information about intra-procedure aspects of the longitudinal care episode, the information about the intra-procedure aspects of the longitudinal care episode being stored as supplemental data in the longitudinal episode data, the tool manager to provide the supplemental data to the health record system for documenting the information about the intra-procedure aspects of the longitudinal care episode into the health record for the patient.

20. A non-transitory computer-readable medium that includes instructions which, when executed by a processor, cause the processor to:
aggregate context data for a patient, at least a portion of the context data including patient data associated with a longitudinal care episode;
provide a graphical user interface (GUI) responsive to user interactions;
translate the user interactions with the GUI into corresponding discrete concepts;
generate and store longitudinal episode data based on the context data and in response to the user interactions with the GUI;
store the corresponding discrete concepts in memory as part of the longitudinal episode data for the patient, whereby documentation and management of multiple phases of the longitudinal care episode is facilitated.

21. The medium of claim 20, wherein the instructions are further to:
access patient data in an electronic health record (EHR) system; and
selectively store the longitudinal episode data in the EHR system to document aspects for each of the multiple phases of the longitudinal care episode.

22. The medium of claim 20, wherein the instructions are further to:
compute a prediction output for at least one phase of the multiple phases based on the longitudinal episode data for the at least one phase; and
store the prediction output and user interactions related to the prediction output as part of the longitudinal episode data for the at least one phase.

23. The medium of claim 22, wherein the instructions are further to generate a recommended action via the GUI based on the prediction output and a computed accuracy of the prediction output.

24. The medium of claim 22, wherein the instructions are further to:
generate an interactive consent document based on the longitudinal episode data for a pre-procedure phase of the multiple phases, and at least one prediction output computed for the pre-procedure phase;
store patient interaction data in the longitudinal episode data for the pre-procedure phase based on user interactions with the interactive consent document.

25. The medium of claim 20, wherein the longitudinal episode data comprises coded data elements, each of the coded elements being programmed, according to a prescribed code standard, to represent a respective aspect of the longitudinal care episode for the patient, the instructions are further to detect deviations and enforce consistency of the longitudinal episode data between successive phases of the multiple phases of the longitudinal care episode based on a comparison of corresponding coded data elements in the successive phases.
